(19) United States
(12) Patent Application Publication
(10) Pub. No.: US 2005/0224526 A1
(43) Pub. Date: Oct. 13, 2005

(54) Spray bottle suction straw diversion device

(76) Inventor: John Wilmer Ward II, Huntsville, AL (US)

Correspondence Address: JOHN W. WARD II, 1210 SE WILMINGTON RD., HUNTSVILE, AL, 35803, US

(21) Appl. No.: 10/818,535

(22) Filed: Apr. 5, 2004

(51) Int. Cl. B67D 5/40

(52) U.S. Cl. 222/464.7

(57) ABSTRACT

A spray bottle that has a Suction Straw Diversion Device (SSDD) that diverts or directs the sprayer pump suction straw towards the perimeter of the bottle. This can be accomplished through the use of a protrusion, bar, tube, rail, plate, hook or any other device built into the bottle that will keep the suction straw diverted to the perimeter of the bottle and in the liquid thus allowing it to be dispensed.

### BACKGROUND OF THE INVENTION

1. Technical Field

This invention relates in general to bottles and in particular to spray bottles.

2. Description of Related Art

Bottles are used to contain liquids of various types.

Bottles are used to mix solutions or a solution and powder in order to achieve a mixture that is desired.

Bottles are used as part of an application device, as in a spray bottle, to spray liquids onto vertical and horizontal surfaces which may be higher or lower than the bottle is being held.

Currently, when purchasing a cleaning product at the store, the spray bottles do not allow the consumer to use as much of the product as possible, especially if spraying a horizontal surface where the spray bottle must be leaned forward to spray downward or backward to spray upward. In many cases this leaves between 40-80 ml of liquid in the bottle that can't be consumed using the sprayer as designed to be used as a sprayer applicator.

### BRIEF SUMMARY OF THE INVENTION

This invention recognizes that spray bottles currently being used to dispense liquids through a pump sprayer do no adequately use as much of the liquid as possible. Currently most spray bottles do not allow the user to use the last 40 to 80 milliliters of liquid in the bottom of the bottle when spraying the surface of a table or any other horizontal surface. A spray bottle with my invention of a suction straw diversion device allows the user to use all but approximately 0.5 to 1 milliliters by directing the sprayer suction straw towards the front of the bottle where the liquid pools when the bottle is tilted forward so that a horizontal surface can be sprayed and liquid is dispensed easily. It also allows the spray bottle to use as much of the liquid in the bottle as possible when spraying upward, simply by turning the sprayer device to face backwards, but leaving the suction straw directed toward the front of the bottle where the liquid will pool when the bottle is tilted.

### BRIEF DESCRIPTION OF THE DRAWINGS

FIG. 1: shows a round spray bottle standing upright with very little liquid in the bottle. The sprayer suction straw is going straight down and is in the liquid thus allowing the liquid to be sprayed. (1) Indicates liquid level.

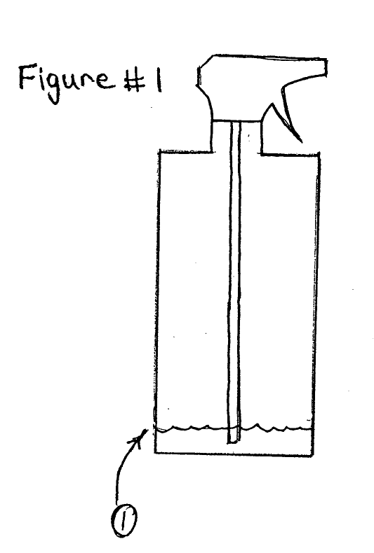

FIG. 2: shows a round spray bottle tilted forward with the sprayer suction straw going straight down and the liquid pooling a the front of the bottle not allowing the sprayer to spray the liquid. (1) Indicates liquid level.

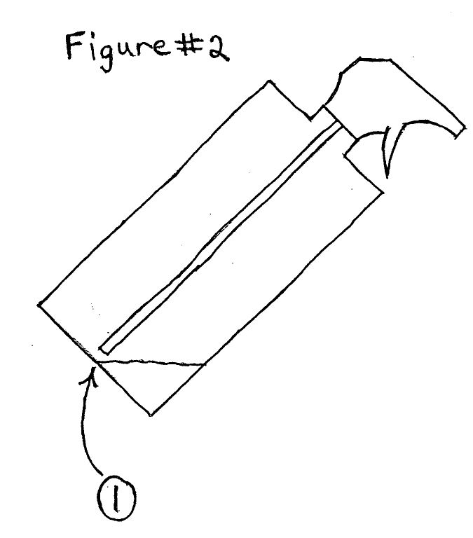

FIG. 3: shows a round spray bottle upright with very little liquid with the sprayer suction straw diverted by the Suction Straw Diversion Device (SSDD) diverting the suction straw towards the perimeter of the bottle and in the liquid. (1) Indicates liquid level. (2) Indicates the Suction Straw Diversion Device (SSDD).

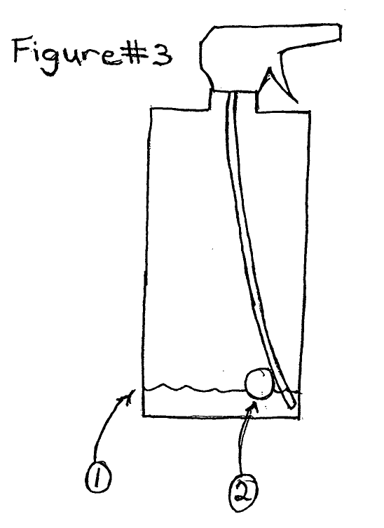

FIG. 4: shows a tilted round spray bottle with the SSDD diverting the suction straw towards the perimeter of the bottle where a very low level of liquid is pooling and the suction straw still in the liquid, thus being able to be sprayed. (1) Indicates liquid level. (2) Indicates the Suction Straw Diversion Device (SSDD).

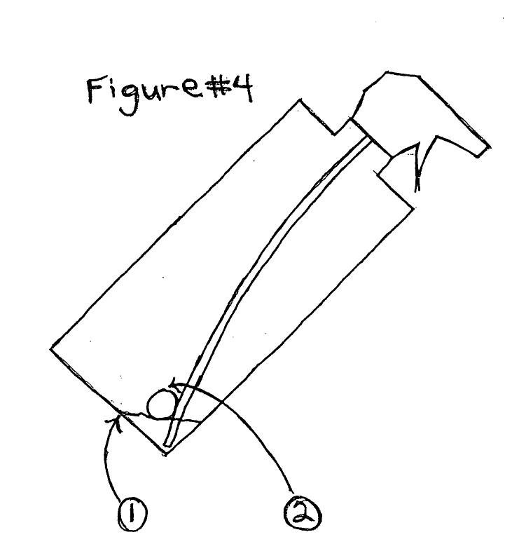

FIG. 5: shows an oblong spray bottle standing upright with very little liquid in the bottle. The sprayer suction straw is going straight down and is in the liquid thus allowing the liquid to be sprayed. (1) Indicates liquid level.

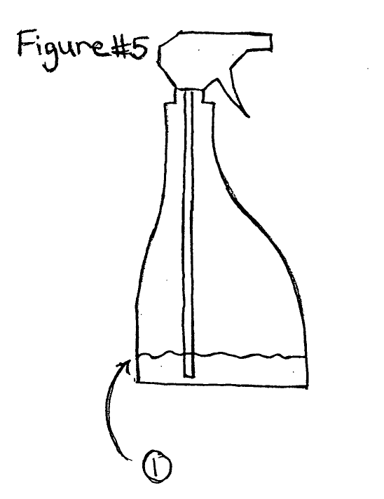

FIG. 6: shows an oblong spray bottle tilted forward with the sprayer suction straw going straight down and the liquid pooling a the front of the bottle not allowing the sprayer to spray the liquid. (1) Indicates liquid level.

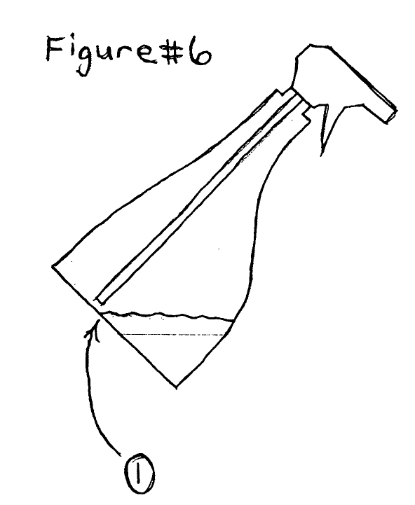

FIG. 7: shows an oblong spray bottle upright with very little liquid with the sprayer suction straw diverted by the Suction Straw Diversion Device (SSDD) diverting the suction straw towards the perimeter of the bottle and in the liquid. (1) Indicates liquid level. (2) Indicates the Suction Straw Diversion Device (SSDD).

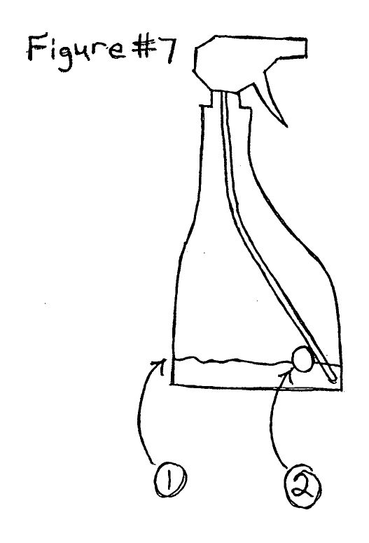

FIG. 8: shows a tilted oblong spray bottle with the SSDD diverting the suction straw towards the perimeter of the bottle where a very low level of liquid is pooling and the suction straw still in the liquid, thus being able to be sprayed. (1) Indicates liquid level. (2) Indicates the Suction Straw Diversion Device (SSDD).

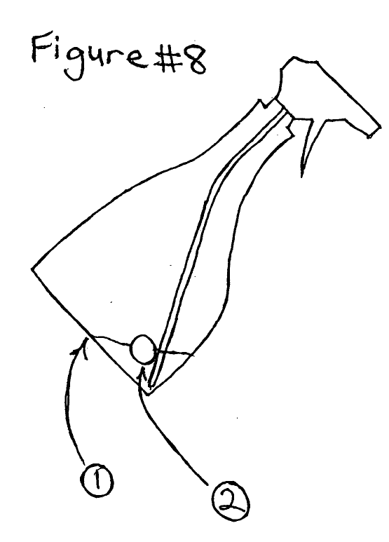

FIG. 9: shows an oblong spray bottle upright with the sprayer device turned around to face the back of the bottle with a low liquid level and the suction straw diverted to the front of the bottle by the SSDD and the straw still in the liquid. (1) Indicates liquid level. (2) Indicates the Suction Straw Diversion Device (SSDD).

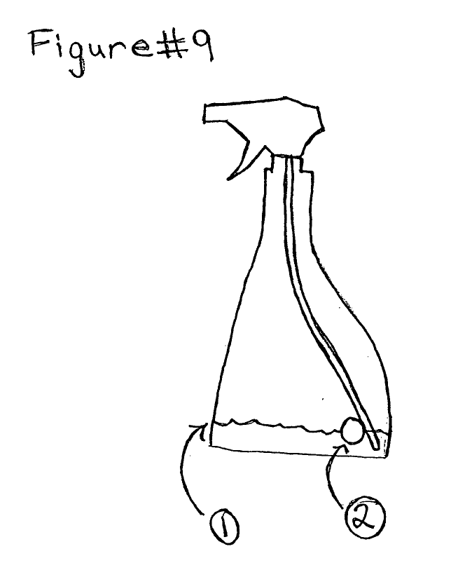

FIG. 10: shows an oblong spray bottle leaning forward with the sprayer turned facing the back of the bottle. The bottle has a low level of liquid and the suction straw is diverted towards the front of the bottle with the suction straw in the liquid allowing it to be sprayed upwards. (1) Indicates liquid level. (2) Indicates the Suction Straw Diversion Device (SSDD).

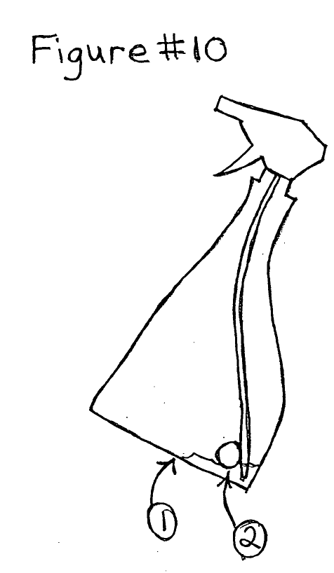

FIG. 11: shows an oblique view of an oblong spray bottle with a SSDD diverting the suction straw towards the front of the bottle. (1) Indicates the Suction Straw Diversion Device (SSDD).

### DETAILED DESCRIPTION OF THE INVENTION

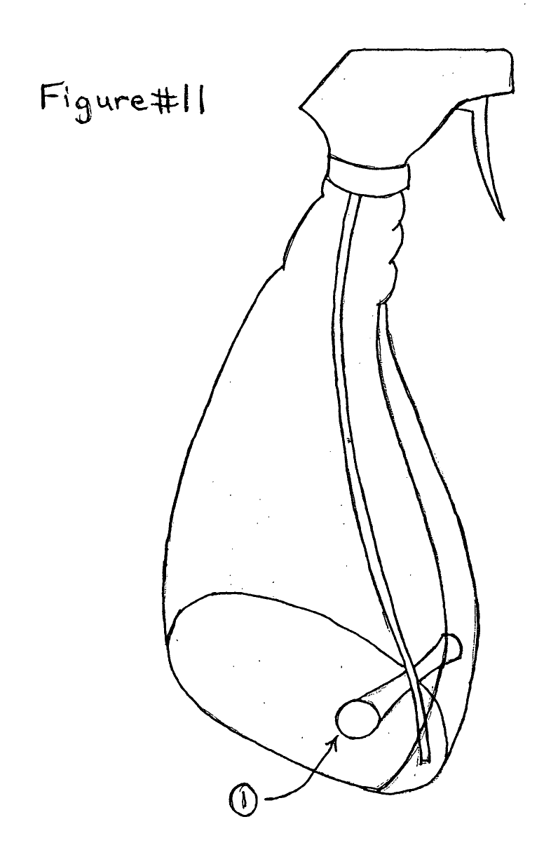

This invention of a Suction Straw Diversion Device (SSDD) is built into bottles that are produced through plastic injection molding or other processes common to bottle making. Bottles with a SSDD can be similar to any spray bottles currently on the market today. For the purpose of this paper, two bottle shapes will be used, but the concept of the SSDD can be used in any of the bottle designs. This spray bottle has a SSDD that is double tapered hollow/tubular in design. (See FIG. 11, (1).) It is located near the bottom-lower part of the spray bottle and is located towards the front or near the edge of the spray bottle depending on the bottle design. A spray bottle with a SSDD pushes the sprayer bottles sprayer suction straw to any area of the perimeter at the bottom of the bottle next to the wall of the bottle. This allows the bottle to be more efficient and allows it to suck up and spray the contents of the bottle when the bottle is at a low to almost empty stage.

1. This bottle has a double taper hollow/tubular Suction Straw Diversion Device (SSDD) that runs horizontally through the bottle from one side to the other side. It is located in the lower front area of the spray bottle. Beside the functional aspect of the SSDD, it gives the spray bottle a marketing/advertising advantage over other spray bottles. The SSDD gives the spray bottle a “see through hole in the bottle” design. People see the bottle, get curious, pick it up, read the “direction for use” label, wonder how good it works, so they buy it to find out.

2. The spray bottle of claim 1, allows the user to consume much more of the liquid product in the bottle than other spray bottle designs allow.

3. The spray bottle of claim 1, diverts the suction straw from going straight down towards the front of the bottle.

4. The sprayer bottle of claim 1, keeps the suction straw near the left/right center line of the bottle.

5. The spray bottle of claim 1, the SSDD is located in the lower front area to prevent problems when filling the bottle with liquids.

6. The spray bottle of claim 1, the SSDD helps mix any powder or liquid added together when the bottle is shaken.

7. The spray bottle of claim 1, the SSDD is tubular in design going through the bottle from one side of the bottle to the other side.

8. The spray bottle of claim 1, the SSDD has unobstructed openings at both ends.

9. The spray bottle of claim 1, the SSDD is hollow and provides an unobstructed view through the bottle.

10. The spray bottle of claim 1, the SSDD gives the illusion or appearance that there is a “hole in the bottle”.

11. The spray bottle of claim 1, the appearance of a “hole in the bottle” has an advertising advantage in that an advertisement can say something like . . . Just look for the cleaner with the “hole in the bottle”.

12. The spray bottle of claim 1, has such a novel design it will catch the consumers eye and get their curiosity up getting them to pick it up to get a better look.

13. The spray bottle of claim 1, once the consumer picks up the bottle out of curiosity, they will read the “direction for use” label and see what the “hole in the bottle” is really used for.

14. The spray bottle of claim 1, once the consumer picks up and reads the “direction for use” label, they will want to know and see how it works so they will buy one and try it out.
